(19) United States
(12) Patent Application Publication
(10) Pub. No.: US 2004/0185782 A1
(43) Pub. Date: Sep. 23, 2004

(54) Technique for selecting a signal path in an antenna system

(76) Inventors: Steven Dennis Halford, Palm Bay, FL (US); Mark Alan Webster, Indian Harbor Beach, FL (US); Maarten Menzo Wentink, Utrecht (NL); James Gerard Zyren, Melbourne Beach, FL (US)

Correspondence Address: DEMONT & BREYER, LLC, SUITE 250, 100 COMMONS WAY, HOLMDEL, NJ, 07733, US

(21) Appl. No.: 10/685,131

(22) Filed: Oct. 14, 2003

Related U.S. Application Data
(60) Provisional application No. 60/455,323, filed on Mar. 17, 2003.

(51) Int. Cl. H04M 1/00

(52) U.S. Cl. 455/63.4; 455/63.1

(57) ABSTRACT

An apparatus and method for selecting between the signal paths of an antenna system is disclosed. The illustrative embodiment provides an efficient selection technique wherein the antenna system is the steerable beam type, in which directionally distinct beams are formed. The illustrative embodiment also provides an efficient selection technique wherein the antenna system is the diversity switching type, in which multiple, distinct antennas are used. The technique in the illustrative embodiment reduces the number of directed (i.e., addressed) frames that are lost compared with other techniques and, as a result, improves network performance.

### CROSS-REFERENCE TO RELATED APPLICATIONS

This application claims the benefit of U. S. Provisional Patent Application Serial No.: 60/455,323, entitled “Technique for Steering an Antenna System,” filed on 17 Mar. 2003, which is incorporated by reference.

### FIELD OF THE INVENTION

The present invention relates to telecommunications in general, and, more particularly, to wireless local area networks.

### BACKGROUND OF THE INVENTION

FIG. 1 depicts a schematic diagram of local area network 100 in the prior art, which comprises telecommunication stations 101-1 through 101-K, wherein K is a positive integer, and shared-communications channel 102, interconnected as shown. Stations 101-1 through 101-K enable associated host computers to communicate blocks of data, or “frames,” to each other.

Stations 101-1 through 101-K each employs an antenna system that is used to interface with shared-communications channel 102 and to enhance system performance. Shared-communications channel 102 can be, for example, a radio frequency channel. The antenna system enhances system performance by providing gain (e.g., array gain, directional gain, etc.) to increase range, data rate, or system reliability, alone or in combination. Antenna systems include the steerable beam type and the diversity switching type.

FIG. 2 depicts a steerable beam antenna system in the prior art. A beam is analogous to a “window” that faces a particular direction through which signals can be transmitted or received. Typically, the steerable beam antenna system employs multiple antennas 202-1 through 202-N (wherein N is a positive integer greater than one) and beamformer 201 to form beams 203-1 through 203-M (wherein M is a positive integer) steered in different directions. Selection switch 204 selects the beam of the best signal quality from beams 203-1 through 203-M.

FIG. 3 depicts a diversity-switching antenna system with multiple antennas 302-1 through 302-N (wherein N is a positive integer greater than one) in the prior art. Rather than providing directional gain, diversity schemes typically involve the use of multiple antennas, each of which might or might not have significant directional gain. The diversity system selects via selection switch 301 the antenna 302-1 through 302-N that provides the best signal quality. Often, antennas 302-1 through 302-N will be separated sufficiently to ensure that they do not simultaneously experience signal degradation.

The radio frequency (RF) environment of shared-communications channel 102 is dynamic. Conditions can change periodically or sporadically, and antenna systems must be able to adapt accordingly. Thus, systems that employ steerable beams (or diversity switching) must have some means of determining which beam (or antenna) is optimal on a continual basis.

In the prior art, antenna steering or switching relies on either of two methods:

1. Switch among beams (or antennas in the case of diversity switching) using a signal quality metric derived during a frame to determine which beam (or antenna) is optimal, or

2. Switch among beams (or antennas) based on other information not derived from the immediately arriving signal.

The first method is often referred to as “hardware diversity” because it relies on signal metrics derived in the radio and baseband processor. The second method is called “software diversity” because the decision metric is based on some algorithm that operates at a higher level of the signal processing path.

Hardware diversity is considered superior to software diversity because the beam (or antenna) is selected at the start of each incoming frame that is directed (i.e., addressed) to the receiving station (i.e., “directed frame”). The selection is based on a measure of signal quality determined during the frame preamble, which is a string of bits within the frame typically used for synchronization and timing purposes.

The main disadvantage of hardware diversity is that signal quality must be checked on multiple beams (or antennas) during the frame preamble. Some types of wireless local area network transmission protocols, such as Institute of Electrical and Electronics Engineers (IEEE) 802.11b, specify relatively lengthy preambles that provide adequate time to facilitate the use of hardware diversity. Newer versions, however, of wireless local area network transmission protocols, such as IEEE 802.11a or 802.11g, specify much shorter preambles in order to minimize network overhead. As a result, hardware diversity is often impractical for those applications.

Software diversity is often used in those situations for which the frame preamble is too short to permit use of hardware diversity. Software diversity is not based directly on signal quality for each incoming frame. Instead, system performance is monitored over some longer period of time and a performance metric, such as frame error rate (FER), is determined. The beam (or antenna) is switched periodically or sporadically to determine which one renders the best performance.

Although software diversity can be used in conjunction with shorter preambles, the disadvantage of software diversity is that several directed frames might be dropped before the system responds to the degradation in performance.

What is needed is a technique to improve wireless network performance without some of the disadvantages of the prior art.

### SUMMARY OF THE INVENTION

The present invention provides a technique to improve wireless network performance. The technique in the illustrative embodiment of the present invention selects the optimal steered beam or diversity antenna based on the signal quality of beacon frames transmitted by an access point, rather than on any metric based on the directed frames. Therefore, the directed frames are no longer placed directly at risk. Furthermore, the sporadic loss of a beacon frame during signal quality estimation is tolerable because i) the access point transmits beacon frame signals continually and ii) the information contained in consecutive beacon frame signals (i.e., signals that represent the transmitted beacon frames) is highly redundant.

The technique in the illustrative embodiment can be used in conjunction with transmission methods that utilize either short preambles (such as Institute of Electrical and 802.11a or 802.11g) or long preambles. In short preamble applications, the technique of the illustrative embodiment is superior to hardware diversity, which typically cannot be used at all with short preambles. The technique of the illustrative embodiment is also superior to software diversity because the optimal beam (or antenna) is selected before transmission of a directed frame. Thus, directed frames are not dropped before the system responds to a degradation of signal quality. Furthermore, because of reciprocity, the beam (or antenna) selection is optimal for both the transmit path and the receive path.

In this specification, the illustrative embodiment is disclosed in the context of the IEEE 802.11 set of protocols. It will be clear, however, to those skilled in the art how to make and use alternative embodiments of the present invention for other protocols.

The illustrative embodiment of the present invention comprises: receiving through an antenna system a first portion of a beacon frame signal via a first signal path and a second portion of the beacon frame signal via a second signal path; measuring the signal quality of the first portion of the beacon frame signal and of the second portion of the beacon frame signal; and selecting between the first signal path and the second signal path for receiving a subsequent signal, wherein said selecting is based on the signal quality of the first portion and the second portion of the beacon frame signal.

### BRIEF DESCRIPTION OF THE DRAWINGS

FIG. 1 depicts a schematic diagram of wireless local area network 100 in the prior art.

FIG. 2 depicts a steerable beam antenna system in the prior art.

FIG. 3 depicts an antenna diversity antenna system in the prior art.

FIG. 4 depicts a schematic diagram of a portion of local area network 400 in accordance with the illustrative embodiment of the present invention.

FIG. 5 depicts a block diagram of the salient components of access point 401 in accordance with the illustrative embodiment of the present invention.

FIG. 6 depicts a block diagram of the salient components of station 402-i in accordance with the illustrative embodiment of the present invention.

FIG. 7 depicts timing diagrams of the relationship between beacon frame signals transmitted by access point 401 in a wireless local area network and data signals received by other wireless stations.

FIG. 8 depicts a flowchart of the salient tasks performed by the illustrative embodiment in using beacon frame signals to steer an antenna system to select the optimal signal path.

FIG. 9 depicts a flowchart of the salient tasks performed by the illustrative embodiment in using a special field within a beacon frame to steer an antenna system to select the optimal signal path.

FIG. 10 depicts a flowchart of the salient tasks performed by the illustrative embodiment in using a beacon frame signal to compare against a signal received earlier for the purpose of assessing multiple signal paths.

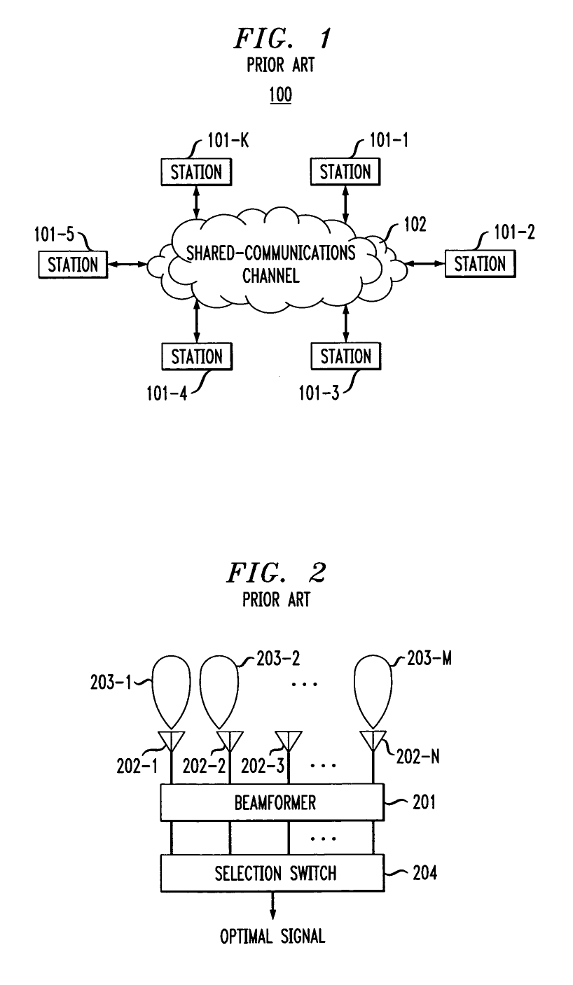

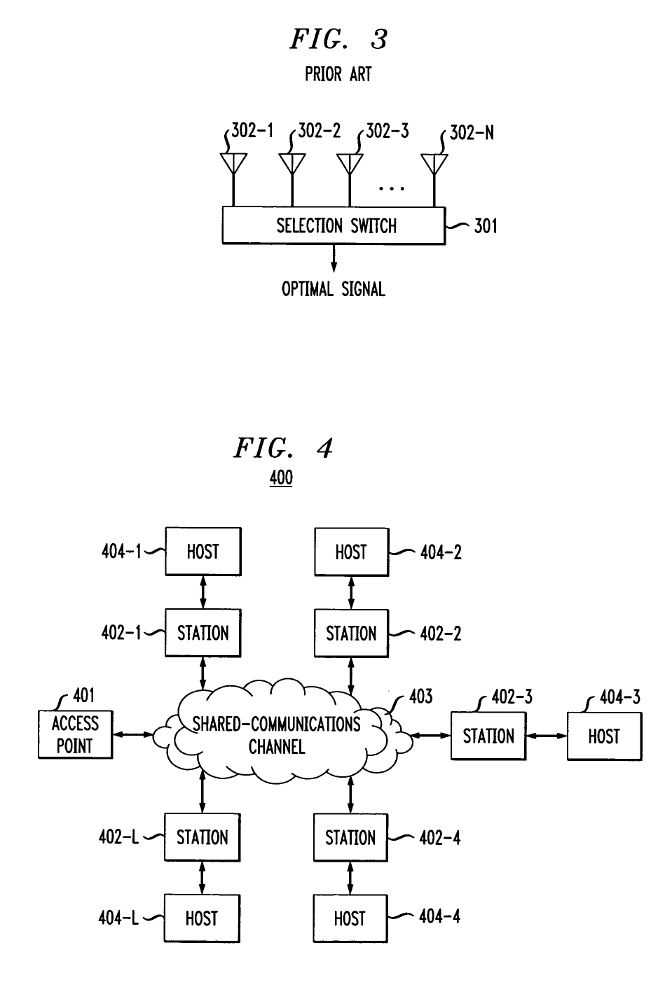

### DETAILED DESCRIPTION

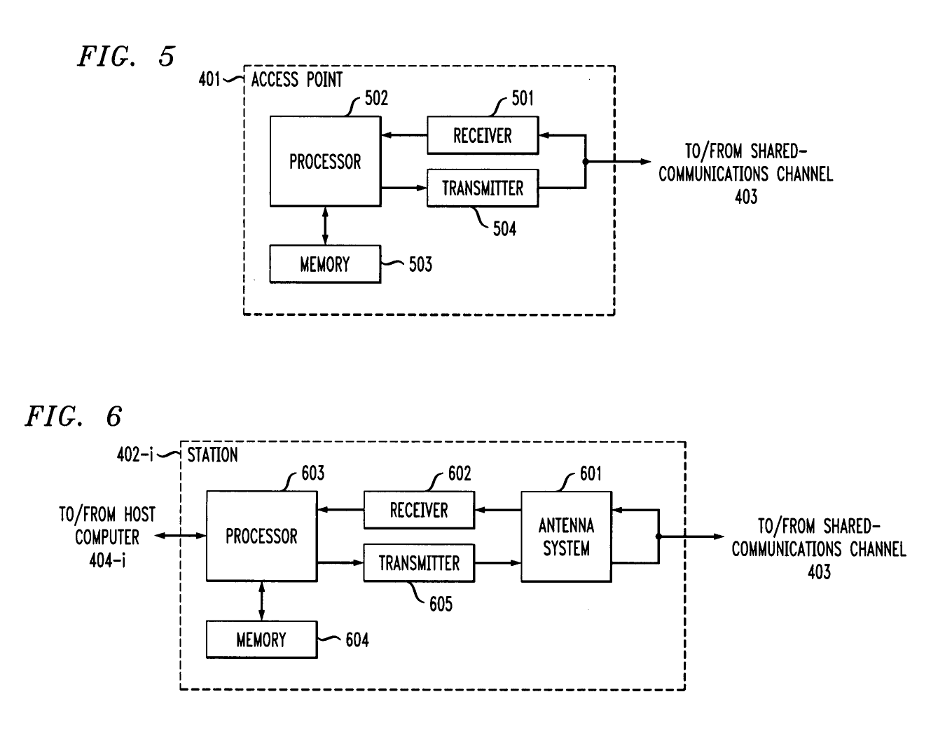

FIG. 4 depicts a schematic diagram of local area network 400 in accordance with the illustrative embodiment of the present invention. Network 400 operates in accordance with the IEEE 802.11 set of protocols and comprises access point 401, stations 402-1 through 402-L, wherein L is a positive integer, host computers 404-1 through 404-L, and wireless shared-communications channel 403, interconnected as shown.

It will be clear to those skilled in the art, after reading this specification, how to make and use embodiments of the present invention that operate in accordance with other protocols. Furthermore, it will be clear to those skilled in the art, after reading this specification, how to make and use embodiments of the present invention that use a wireline or tangible shared-communications channel.

Access point 401, a variation of a wireless station, enables stations 402-1 through 402-L within local area network 400 to communicate with each other, because access point 401 coordinates the communications on local area network 400. Access point 401 broadcasts beacon frames (i.e., “beacons”) to provide network synchronization and to facilitate network management. The salient details of access point 401 are described below and with respect to FIG. 5.

Station 402-i, for i=1 through L, comprises the radios that enable host 404-i to communicate via shared-communications channel 403. Station 402-i is capable of receiving data blocks from host computer 404-i and transmitting over shared-communications channel 403 data frames comprising the data received from host computer 404-i. Station 402-i is also capable of receiving data frames from shared communications channel 403 and sending to host computer 404-i data blocks comprising data from the data frames. It will be clear to those skilled in the art, after reading this specification, how to make and use station 402-i. The salient details for station 402-i are described below and with respect to FIG. 6.

Host computer 404-i is capable of generating data blocks and transmitting those data blocks to station 402-i. Host computer 404-i is also capable of receiving data blocks from station 402-i and of processing and using the data contained within those data blocks. Host computer 404-i can be, for example, a desktop or a laptop computer that uses local area network 400 to communicate with other hosts and devices via access point 401. It will be clear to those skilled in the art how to make and use host computer 404-i.

FIG. 5 depicts a block diagram of the salient components of access point 401 in accordance with the illustrative embodiment of the present invention. Access point 401 comprises receiver 501, processor 502, memory 503, and transmitter 504, interconnected as shown.

Receiver 501 is a circuit that is capable of receiving frames from shared communications channel 403, in well-known fashion, and of forwarding them to processor 502. It will be clear to those skilled in the art how to make and use receiver 501.

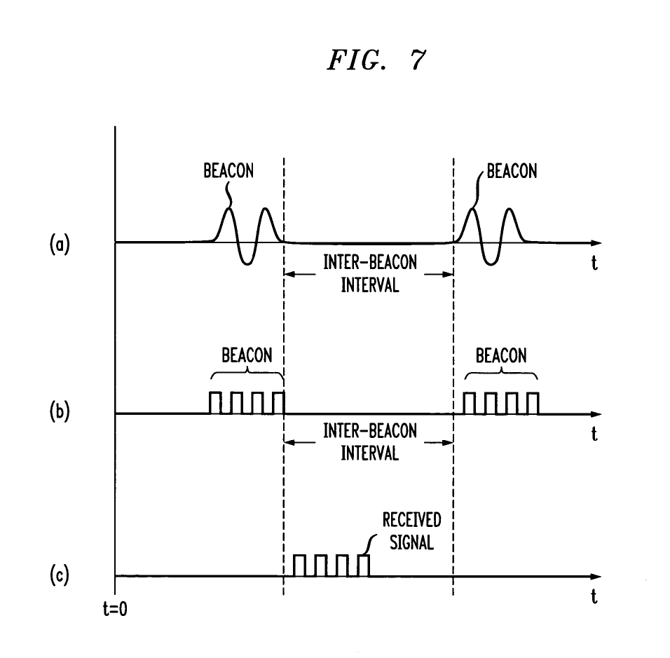

Processor 502 is a general-purpose processor that is capable of performing the tasks described below and with respect to FIG. 7. It will be clear to those skilled in the art, after reading this specification, how to make and use processor 502.

Memory 503 is capable of storing programs and data used by processor 502. It will be clear to those skilled in the art how to make and use memory 503.

Transmitter 504 is a circuit that is capable of receiving frames from processor 502, in well-known fashion, and of transmitting them on shared communications channel 403. It will be clear to those skilled in the art how to make and use transmitter 504.

FIG. 6 depicts a block diagram of the salient components of station 402-i in accordance with the illustrative embodiment of the present invention. Station 402-i is capable of receiving data from a host computer and transmitting frames comprising the data over a shared-communications channel. Station 402-i is also capable of receiving data frames from the shared-communications channel and sending data from the data frames to the host computer.

Station 402-i comprises: antenna system 601, receiver 602, transmitter 603, processor 604, and memory 605, interconnected as shown.

Antenna system 601 is a circuit that is capable of accepting signals from the shared-communications channel and of radiating signals to the shared-communications channel, wherein the signals convey frames. Antenna system 601 switches across multiple signal paths (e.g., beams, antennas, etc.) to provide signals from a switched-in signal path to receiver 602 and to provide signals from transmitter 603 to a switched-in signal path that interfaces with the shared-communications channel. It will be clear to those skilled in the art, after reading this specification, how to make and use antenna system 601.

Receiver 602 is a circuit that is capable of receiving frames from antenna system 601, in well-known fashion, and of forwarding them to processor 604. It will be clear to those skilled in the art how to make and use receiver 602.

Transmitter 603 is a circuit that is capable of receiving frames from processor 604, in well-known fashion, and of transmitting them using antenna system 601. It will be clear to those skilled in the art how to make and use transmitter 603.

Processor 604 is a general-purpose computer that is capable of performing the functions described below and with respect to FIGS. 7 through 10. In some embodiments, processor 604 controls the signal path switching function performed by antenna system 601. It will be clear to those skilled in the art, after reading this specification, how to make and use processor 604.

Memory 605 stores the programs executed by and stores the data used by processor 604. It will be clear to those skilled in the art how to make and use memory 605.

FIG. 7 depicts timing diagrams of the relationship between beacon frame signals transmitted by access point 401 in a wireless local area network and data signals received by other wireless stations. Access point 401 broadcasts beacons at regular intervals (e.g., every 100 milliseconds, etc.). FIG. 7a depicts the beacon frame signal that is radiated from the antenna system of access point 401 over the shared-communications channel. FIG. 7b depicts the underlying beacon frame that is generated within access point 401. FIG. 7c depicts a frame received or transmitted by station 402-i during an “inter-beacon interval,” which is the time interval between successive transmissions of beacon frame signals.

During the inter-beacon interval, a station (e.g., station 402-i, etc.) that is associated with access point 401 might exchange a frame (e.g., a data frame, etc.) with another entity via access point 401. Access point 401 facilitates the frame exchange by providing a bridging function between a number of wireless stations and a wired infrastructure. Furthermore, it is up to access point 401 to forward information from one station to another station as necessary.

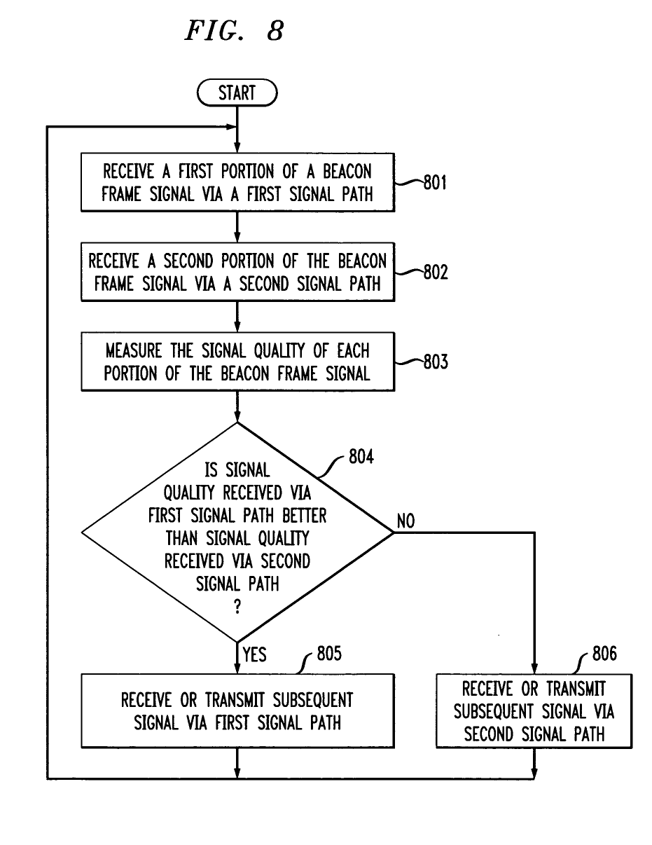

In the illustrative embodiment of the present invention, station 402-i uses access point beacons to select the optimal beam or antenna over the course of time. For FIGS. 8 through 10, a signal path is defined as the path of a received or transmitted signal along a directionally distinct beam in the case of a steerable beam antenna system or through a distinct, individual antenna in the case of an antenna system using diversity switching.

FIG. 8 depicts a flowchart of the salient tasks performed by the illustrative embodiment in using beacon frame signals to steer an antenna system to select the optimal signal path. It will be clear to those skilled in the art which tasks depicted in FIG. 8 can be performed simultaneously or in a different order than that depicted.

At task 801, station 402-i receives a first portion of a beacon frame signal via a first signal path. For example, the first portion of a beacon frame signal might correspond to the beacon frame preamble.

At task 802, station 402-i receives a second portion of a beacon frame signal via a second signal path. For example, the second portion of a beacon frame signal might correspond to the beacon frame header or payload.

At task 803, station 402-i measures in well-known fashion the signal quality received via each signal path as received. In some embodiments, access point 401 inserts a special field into the beacon frames and station 402-i uses the field to enhance signal quality estimation. Station 402-i uses a different portion of the field to measure a signal quality on each signal path. Depending on the length of the field, station 402-i can check signal quality on more than one signal path. In other embodiments, station 402-i receives the beacon on the signal path currently being used, then checks signal quality on one or more alternative signal paths during the receiving of the field before switching back to the currently-used signal path to reliably receive the rest of the beacon. It will be clear to those skilled in the art how to make and use a field for enhancing signal quality estimation.

At task 804, station 402-i selects the signal path with the best signal quality for receiving one or more subsequent signals (e.g., data frames, etc.) or transmitting one or more subsequent signals, or both. If the signal quality of the signal received via the first signal path is better than the signal quality of the signal received via the second signal path, then control proceeds to task 805. Otherwise, control proceeds to task 806.

At task 805, the better signal was measured on the first signal path, so station 402-i receives and transmits subsequent signals via the first signal path.

At task 806, the better signal was measured on the second signal path, so station 402-i receives and transmits subsequent signals via the second signal path.

In some embodiments, station 402-i repeats tasks 801 through 806 for each subsequent beacon frame signal, comparing alternative signal paths (i.e., second signal path) to the currently-used signal path (i.e., first signal path). In other embodiments, station 402-i performs tasks 801 through 806 only on every M^{th} received beacon frame signal, wherein M is a positive integer greater than one.

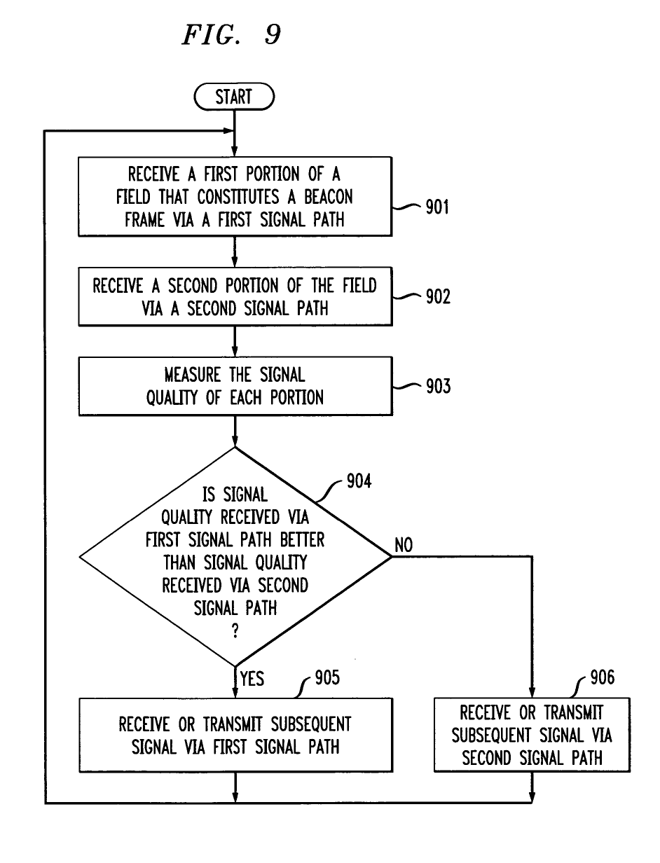

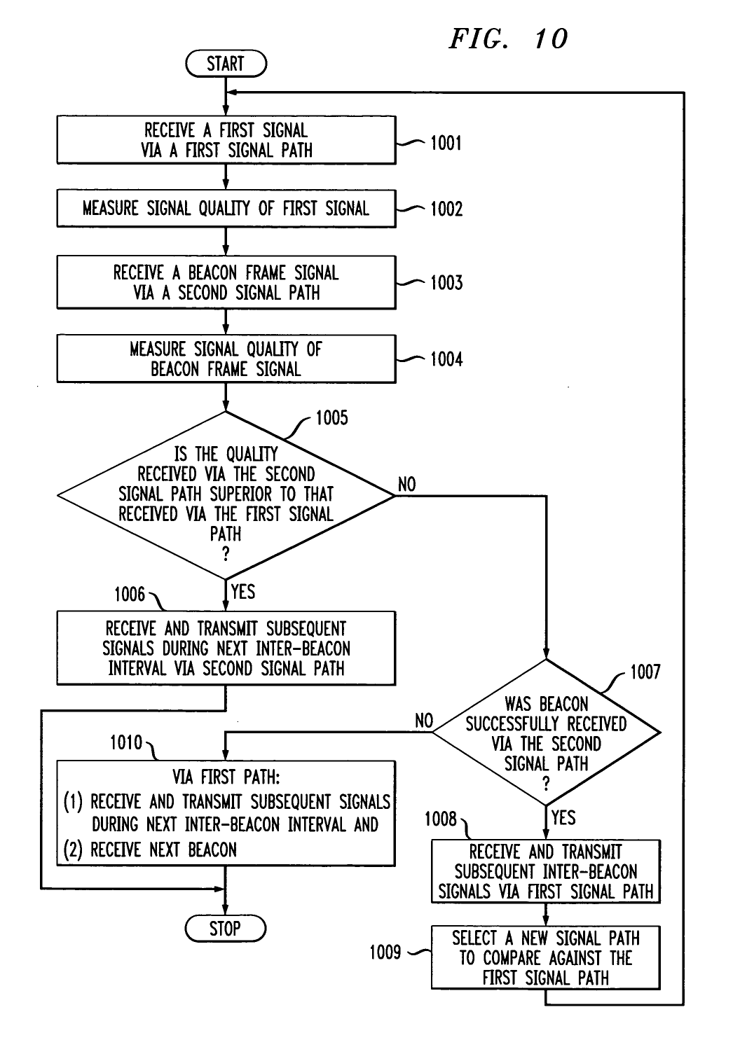

FIG. 9 depicts a flowchart of the salient tasks performed by the illustrative embodiment in using a special field within a beacon frame to steer an antenna system to select the optimal signal path. It will be clear to those skilled in the art which tasks depicted in FIG. 9 can be performed simultaneously or in a different order than that depicted.

At task 901, station 402-i receives a first portion of a field that constitutes a beacon frame signal via a first signal path.

At task 902, station 402-i receives a second portion of a field that constitutes a beacon frame signal via a second signal path.

At task 903, station 402-i measures in well-known fashion the signal quality received via each signal path as received. In some embodiments, station 402-i receives the beacon on the signal path currently being used, then checks signal quality on one or more alternative signal paths during the receiving of the field before switching back to the currently-used signal path to reliably receive the rest of the beacon.

At task 904, station 402-i selects the signal path with the best signal quality for receiving one or more subsequent signals (e.g., data frames, etc.) or transmitting one or more subsequent signals, or both. If the signal quality of the signal received via the first signal path is better than the signal quality of the signal received via the second signal path, then control proceeds to task 905. Otherwise, control proceeds to task 906.

At task 905, the better signal was measured on the first signal path, so station 402-i receives and transmits subsequent signals via the first signal path.

At task 906, the better signal was measured on the second signal path, so station 402-i receives and transmits subsequent signals via the second signal path.

Station 402-i repeats tasks 901 through 906 for each subsequent beacon frame signal, comparing alternative signal paths (i.e., second signal path) to the currently-used signal path (i.e., first signal path).

In other embodiments, station 402-i uses a special frame (rather than field) to assist in signal quality estimation. A uniquely identifiable frame transmitted by access point 401 indicates the start of a signal quality estimation sequence. This starter frame (e.g., a beacon frame, a clear_to_send frame, etc.) contains a duration value that covers for the duration of the estimation sequence. The starter frame is addressed at a well-known multicast address, such as a company-specific multicast range, making the starter frame uniquely identifiable to stations associated with access point 401. When stations (e.g., station 402-i, etc.) receive the starter frame from access point 401, they know that a training sequence will begin a pre-determined period of time after the end of the starter frame. It will be clear to those skilled in the art how to make and use a training sequence for the purpose of estimating signal quality.

FIG. 10 depicts a flowchart of the salient tasks performed by the illustrative embodiment in using a beacon frame signal to compare against a signal received earlier for the purpose of assessing multiple signal paths. It will be clear to those skilled in the art which tasks depicted in FIG. 10 can be performed simultaneously or in a different order than that depicted.

At task 1001, station 402-i receives a first signal via a first signal path (i.e., the currently-used signal path). In some embodiments, the first signal is a beacon frame transmission by an IEEE 802.11 access point.

At task 1002, station 402-i measures in well-known fashion the signal quality of the first signal.

At task 1003, station 402-i receives a beacon frame signal via a second signal path (i.e., an alternative signal path).

At task 1004, station 402-i measures the signal quality of the beacon frame signal.

At task 1005, station 402-i determines if the quality received via the second signal path is superior to that received via the first signal path. If it is, control proceeds to task 1006. If not, control proceeds to task 1007.

At task 1006, station 402-i receives or transmits one or more subsequent signals during the next inter-beacon interval via the second signal path.

At task 1007, station 402-i determines if the beacon frame was at least successfully received via the second signal path. If it was, control proceeds to task 1008. If not, control proceeds to task 1010.

At task 1008, station 402-i receives or transmits one or more subsequent signals during the next inter-beacon interval via the first signal path.

At task 1009, station 402-i selects a new signal path to compare against the first signal path at a later time. Essentially, the new signal path becomes the “second signal path” as depicted in FIG. 10.

At task 1010, station 402-i uses the first signal path to both (1) receive or transmit one or more subsequent signals during the next inter-beacon interval and (2) receive the next beacon frame signal. This minimizes the possibility of station 402-i missing several consecutive beacons.

It is to be understood that the above-described embodiments are merely illustrative of the present invention and that many variations of the above-described embodiments can be devised by those skilled in the art without departing from the scope of the invention. It is therefore intended that such variations be included within the scope of the following claims and their equivalents.

What is claimed is:

1. A method comprising:
receiving through an antenna system a first portion of a beacon frame signal via a first signal path and a second portion of said beacon frame signal via a second signal path;
measuring the signal quality of said first portion of said beacon frame signal and of said second portion of said beacon frame signal; and
selecting between said first signal path and said second signal path for receiving a subsequent signal, wherein said selecting is based on the signal quality of said first portion and said second portion of said beacon frame signal.

2. The method of claim 1 wherein said antenna system is the steerable beam type and wherein said first signal path and said second signal path are along directionally distinct beams.

3. The method of claim 1 wherein said antenna system is the diversity switching type and wherein said first signal path and said second signal path are associated with distinct antennas.

4. The method of claim 1 wherein said selecting comprises:
choosing said first signal path when the signal quality of said first portion is better than the signal quality of said second portion; and
choosing said second signal path when the signal quality of said second portion is better than the signal quality of said first portion.

5. The method of claim 1 wherein said measuring is performed only on every M^{th} received beacon frame signal, wherein M is a positive integer greater than one.

6. The method of claim 1 wherein said beacon frame signal is a transmission of a beacon frame by an access point that operates in accordance with an IEEE 802.11 specification.

7. The method of claim 6 wherein said beacon frame comprises a field for enhancing signal quality estimation.

8. The method of claim 7 wherein said first portion of said beacon frame signal conveys a first portion of said field and said second portion of said beacon frame signal conveys a second portion of said field.

9. A method comprising:
receiving through an antenna system a first portion of a field that constitutes a beacon frame via a first signal path and a second portion of said field via a second signal path;
measuring the signal quality of said first portion as received via said first signal path and of said second portion as received via said second signal path; and
selecting one of said first signal path and said second signal path for receiving a subsequent signal, wherein said selecting is based on the signal quality of said first portion and said second portion of said field.

10. The method of claim 9 wherein said antenna system is the steerable beam type and said first signal path and said second signal path are along directionally distinct beams.

11. The method of claim 9 wherein said antenna system is the diversity switching type and said first signal path and said second signal path are associated with distinct antennas.

12. The method of claim 9 wherein said selecting comprises:
choosing said first signal path when the signal quality of said first portion of said field is better than said signal quality of said second portion of said field; and
choosing said second signal path when the signal quality of said second portion of said field is better than said signal quality of said first portion of said field.

13. The method of claim 9 wherein said local area network is in accordance with an IEEE 802.11 specification.

14. A method comprising:
receiving through an antenna system a first signal via a first signal path on a shared-communications channel;
measuring the signal quality of said first signal;
receiving a portion of a beacon frame signal via a second signal path in said shared-communications channel after said receiving of said first signal;
measuring the signal quality of said portion of said beacon frame signal; and
selecting between said first signal path and said second signal path for receiving a subsequent signal, wherein said selecting is based on the signal quality of said first signal and said beacon frame signal.

15. The method of claim 14 wherein said selecting comprises:
choosing said first signal path when the signal quality of said first signal is better than the signal quality of said beacon frame signal; and
choosing said second signal path when the signal quality of said beacon frame signal is better than the signal quality of said first signal.

16. The method of claim 14 wherein said antenna system is the steerable beam type and wherein said first signal path and said second signal path are along directionally distinct beams.

17. The method of claim 14 wherein said antenna system is the diversity switching type and wherein said first signal path and said second signal path are associated with distinct antennas.

18. The method of claim 14 wherein said shared-communications channel constitutes a local area network that operates in accordance with an IEEE 802.11 specification.

19. The method of claim 14 wherein said first signal is a beacon frame transmission by an access point.

20. The method of claim 14 wherein said beacon frame comprises a field for enhancing signal quality estimation.

21. An apparatus comprising:
an antenna system for switching between a first signal path and a second signal path;
a receiver for receiving a first portion of a beacon frame signal via said first signal path and a second portion of said beacon frame signal via said second signal path; and
a processor for:
(i) measuring the signal quality of said first portion and said second portion of said beacon frame signal; and
(ii) selecting between said first signal path and said second signal path for doing one of receiving and transmitting a subsequent signal, wherein said selecting is based on the signal quality of said first portion and said second portion of said beacon frame signal.

22. The apparatus of claim 21 wherein said antenna system is the steerable beam type and wherein said first signal path and said second signal path are along directionally distinct beams.

23. The apparatus of claim 21 wherein said antenna system is the diversity switching type and wherein said first signal path and said second signal path are associated with distinct antennas.

24. The apparatus of claim 21 wherein said antenna system is also for providing one of said first portion and said second portion of said beacon frame signal to said receiver.

25. The apparatus of claim 21 wherein said beacon frame signal is a transmission of a beacon frame by an access point.

26. The apparatus of claim 25 wherein said beacon frame comprises a field for enhancing signal quality estimation.
